(19) United States
(12) Patent Application Publication
(10) Pub. No.: US 2017/0280104 A1
(43) Pub. Date: Sep. 28, 2017

(54) CAMERA SYSTEM WITH FULL VIEW MONITORING FUNCTION

(71) Applicant: GeoVision Inc., Taipei (TW)

(72) Inventors: Chih-Ming Wu, New Taipei City (TW); Min-Wei Chen, Taipei City (TW); Fu-Fan Cheng, Taipei City (TW)

(21) Appl. No.: 15/077,887

(22) Filed: Mar. 22, 2016

(51) Int. Cl. H04N 7/18; H04N 5/232; H04N 5/225

(52) U.S. Cl. CPC H04N 7/181; H04N 5/2251; H04N 5/23296; H04N 5/23238

(57) ABSTRACT

A camera system with a full view monitoring function includes a base, a first camera apparatus, a supporting component, a second camera apparatus and a wireless transmission module. A circuit board is disposed on the base. The first camera apparatus is movably disposed on the base and electrically connected with the circuit board. The supporting component is disposed on the base. The second camera apparatus is disposed on the supporting component to be located above the first camera apparatus. The wireless transmission module includes a first terminal and a second terminal. The first terminal is electrically connected with the circuit board. The second terminal is disposed on the second camera apparatus and adjacent by the first terminal, and wireless transmission connection is established between the first terminal and the second terminal to electrically connect the second camera apparatus with the circuit board.

### BACKGROUND OF THE INVENTION

1. Field of the Invention

The present invention relates to a camera system, and more particularly, to a camera system having the PTZ camera and the panoramic camera for providing the full view monitoring function.

2. Description of the Prior Art

A monitoring system is extensively applied to the public place, such as the train station, the supermarket, the street and so on. A fisheye camera or a PTZ camera is applied to the conventional monitoring system. Capturing orientation of the fisheye camera is unchangeable, and the fisheye camera captures a panorama image to view a large area within an environment. However, the edge of the panorama image may be indistinct because of optical distortion phenomenon, and cannot clearly provide detailed characteristic for image identification, so that the PTZ camera is applied to accordingly combine with the panoramic camera to capture the characteristic that is blurred in the panorama image. The PTZ camera represents the camera lens can be panned, tilted and zoomed in/out to capture the small-size image. A conventional combination of the PTZ camera and the panoramic camera results in difficulty of complicated machinery disposition, for example, a cable electrically connected between the PTZ camera and the panoramic camera is easily twisted and damaged while the PTZ camera rotates relative to the panoramic camera, and design of a camera system having the PTZ camera and the panoramic camera with preferred mechanism synthesis is an important issue in the monitor apparatus industry.

### SUMMARY OF THE INVENTION

The present invention provides a camera system having the PTZ camera and the panoramic camera for providing the full view monitoring function for solving above drawbacks.

According to the claimed invention, a camera system with a full view monitoring function includes a base, a first camera apparatus, a supporting component, a second camera apparatus and a wireless transmission module. A circuit board is disposed on the base. The first camera apparatus is movably disposed on the base and electrically connected with the circuit board. The supporting component is disposed on the base. The second camera apparatus is disposed on the supporting component to be located above the first camera apparatus. The wireless transmission module includes a first terminal and a second terminal. The first terminal is electrically connected with the circuit board. The second terminal is disposed on the second camera apparatus and adjacent by the first terminal, and wireless transmission connection is established between the first terminal and the second terminal to electrically connect the second camera apparatus with the circuit board.

According to the claimed invention, the first terminal is spaced from the second terminal in a non-contacting manner, and a distance between the first terminal and the second terminal is constrained within a predetermined value while the first camera apparatus is moved relative to the base.

According to the claimed invention, a signal is transmitted between the first terminal and the second terminal by electromagnetic induction technique, magnetic resonance technique, laser induction technique, microwave transducing technique, voltage effect technique or electrical conduction technique.

According to the claimed invention, the first terminal slidably contacts against the second terminal, the first terminal is not separated from the second terminal while the first camera apparatus is moved relative to the base.

According to the claimed invention, the first terminal and the second terminal respectively are a conductive roller and a conductive plate, and the conductive roller slides over the conductive plate for signal transmission.

According to the claimed invention, a rotation axis of the first camera apparatus is substantially equal to a central axis of the second camera apparatus.

According to the claimed invention, the supporting component is a protective mask assembled with the base, and the second camera apparatus is suspended from the protective mask.

According to the claimed invention, the second camera apparatus is disposed on the protective mask in an engaging manner, a locking manner, an adhesive manner or a thermal melting manner.

According to the claimed invention, the supporting component is a holder, an end of the holder is disposed on the base, and the other end of the holder whereon the second camera apparatus is disposed is bent to be suspended upon another surface connected to the foresaid surface of the first camera apparatus.

According to the claimed invention, the camera system further includes a rotary mechanism disposed on the base, the first camera apparatus being disposed on the rotary mechanism to move relative to the base.

According to the claimed invention, the rotary mechanism includes a bridging portion adjacent to a bottom of the second camera apparatus, the first terminal is disposed on the bridging portion, and the second terminal is disposed on the bottom of the second camera apparatus.

According to the claimed invention, the rotary mechanism includes a surrounding portion adjacent to a lateral side of the second camera apparatus, the first terminal is disposed on the surrounding portion, and the second terminal is disposed on the lateral side of the second camera apparatus.

According to the claimed invention, the first camera apparatus is panned and tilted by the rotary mechanism, and the second camera apparatus is a panoramic camera.

The camera system of the present invention combines the panoramic camera with the PTZ camera to provide the full view monitoring function. Overlap of the panoramic camera and the PTZ camera can increase stability of the integral inertia moment of the camera system. The wireless transmission connection is preferably applied to the camera system to overcome conventional constraint about cable length and cable quantity. The panoramic camera and/or the PTZ camera of the camera system can be modularized to be beneficial for product expansion and upgrading.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is an assembly diagram of a camera system with a full view monitoring function according to a first embodiment of the present invention.

FIG. 2 is an exploded diagram of the camera system according to the first embodiment of the present invention.

FIG. 3 is a sectional view of the camera system according to the first embodiment of the present invention.

FIG. 4 is an assembly diagram of the camera system according to a second embodiment of the present invention.

FIG. 5 is an exploded diagram of the camera system according to the second embodiment of the present invention.

FIG. 6 is a sectional view of the camera system according to the second embodiment of the present invention.

FIG. 7 is a diagram of the camera system according to a third embodiment of the present invention.

FIG. 8 is a diagram of the camera system according to a fourth embodiment of the present invention.

### DETAILED DESCRIPTION

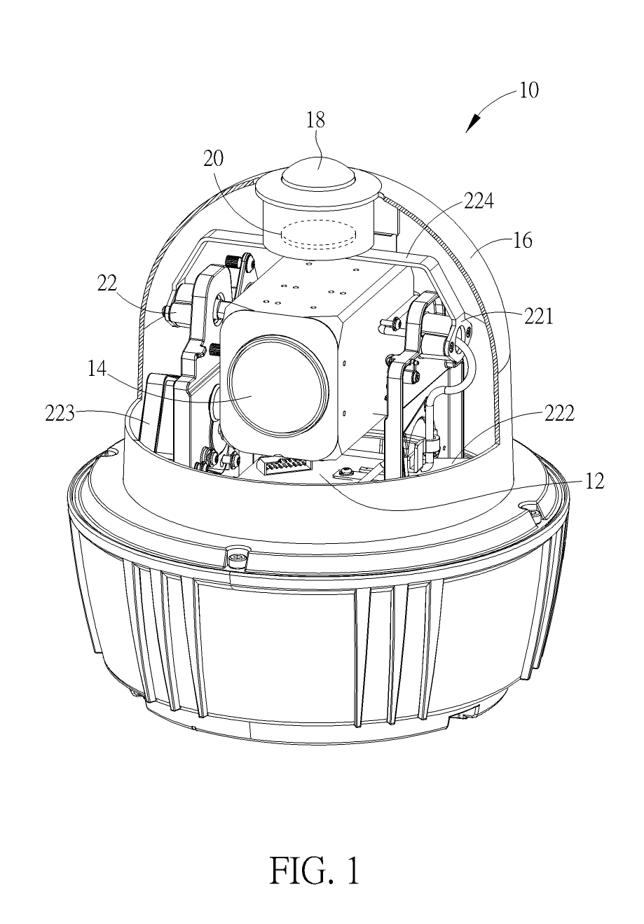

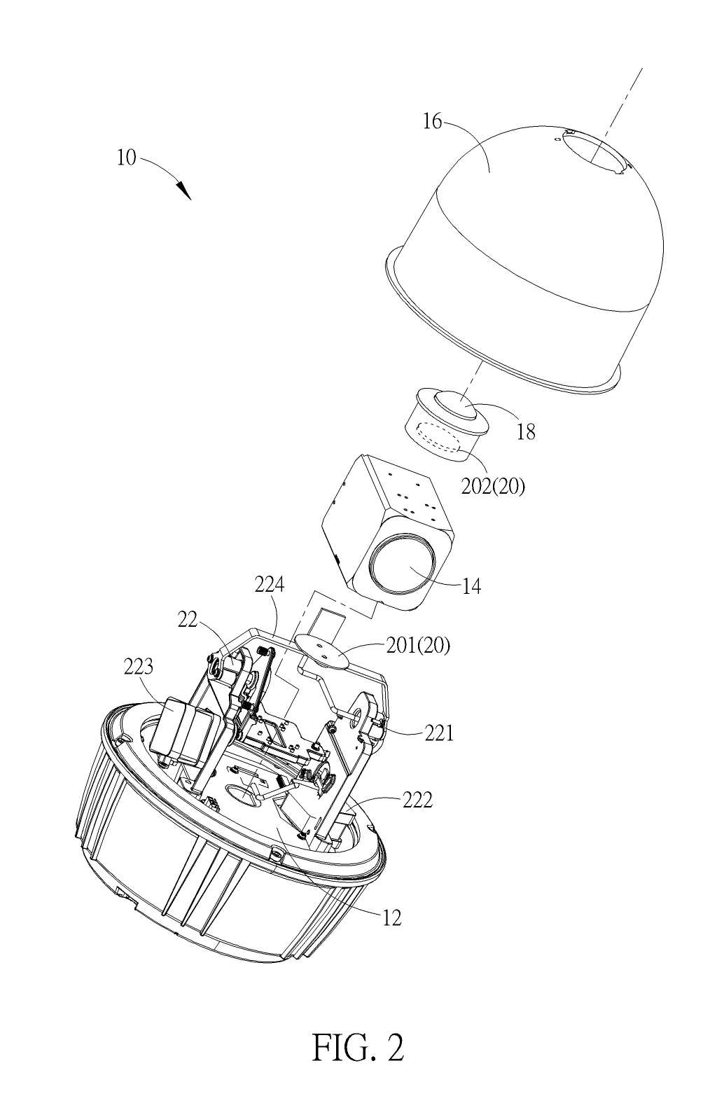

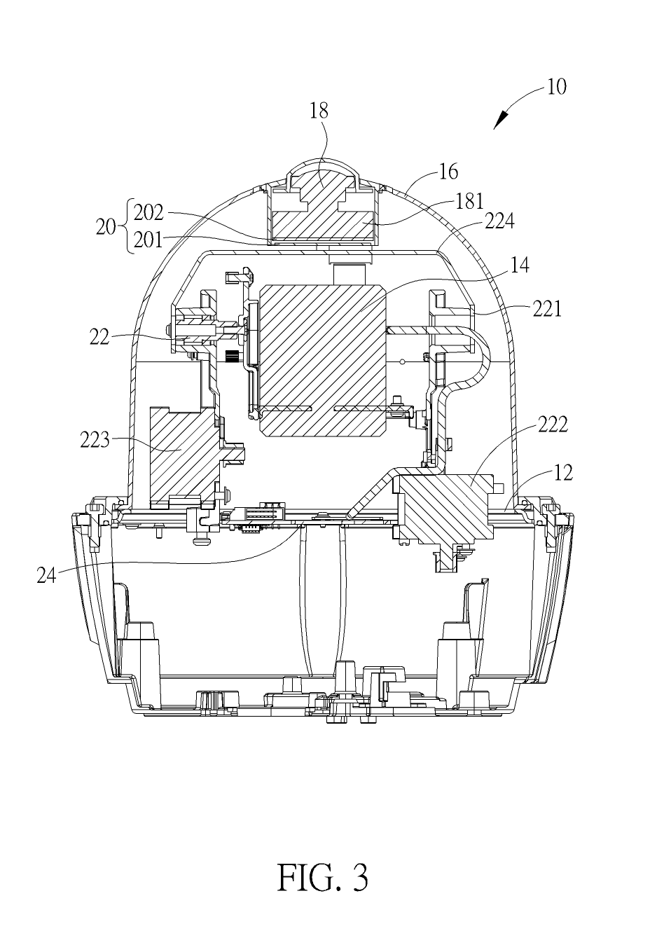

Please refer to FIG. 1 to FIG. 3. FIG. 1 is an assembly diagram of a camera system 10 with a full view monitoring function according to a first embodiment of the present invention. FIG. 2 is an exploded diagram of the camera system 10 according to the first embodiment of the present invention. FIG. 3 is a sectional view of the camera system 10 according to the first embodiment of the present invention. The camera system 10 includes a base 12, a first camera apparatus 14, a supporting component 16, a second camera apparatus 18, a wireless transmission module 20 and a rotary mechanism 22. A circuit board 24 is disposed on the base 12. The first camera apparatus 14 is movably disposed on the base 12 via the rotary mechanism 22 and electrically connected with the circuit board 24. Thus, the rotary mechanism 22 includes a bracket 221, a first motor 222 and a second motor 223. The bracket 221 whereon the first camera apparatus 14 is positioned is disposed on the base 12, the first motor 222 adjusts a rotation angle of the bracket 221 to pan the first camera apparatus 14, the second motor 223 adjusts a depression/elevation angle of the bracket 221 to tilt the first camera apparatus 14, and the first camera apparatus 14 has zoom in/out function, so that the first camera apparatus 14 preferably can be the PTZ camera. While the second camera apparatus 18 is set as a panoramic camera, the camera system 10 having the PTZ camera and the panoramic camera can provide the full view monitoring function.

In the first embodiment, the supporting component 16 is a protective mask assembled with the base 12, and the second camera apparatus 18 is suspended from the protective mask to be located above the first camera apparatus 14. For example, the second camera apparatus 18 can be fixed onto the protective mask in an engaging manner, a locking manner, an adhesive manner or a thermal melting manner. The wireless transmission module 20 includes a first terminal 201 and a second terminal 202, the first terminal 201 is disposed on a bridging portion 224 of the rotary mechanism 22 and electrically connected with the circuit board 24, and the second terminal 202 is disposed on a bottom 181 of the second camera apparatus 18. The bridging portion 224 may stretch from the bracket 221. The bridging portion 224 is close to the bottom 181, and accordingly the second terminal 202 is adjacent by the first terminal 201 in a non-contacting manner.

That is to say, the first terminal 201 is spaced from the second terminal 202, a signal can be transmitted between the first terminal 201 and the second terminal 202 by electromagnetic induction technique, magnetic resonance technique, laser induction technique, microwave transducing technique, voltage effect technique and/or electrical conduction technique, which means wireless transmission connection is established between the first terminal 201 and the second terminal 202 for electrically connecting the second camera apparatus 18 with the circuit board 24. The circuit board 24 may have a built-in processor or be connected to an external processor for digital signal process. It should be mentioned that the bridging portion 224 is kept in a stable level relative to the base 12 while the first camera apparatus 14 is rotated by the rotary mechanism 22. Because the first terminal 201 is fixed onto the bridging portion 224, and the second terminal 202 is fixed onto the supporting component 16 via the second camera apparatus 18, a distance between the first terminal 201 and the second terminal 202 can be constrained within a predetermined value while the rotary mechanism 22 drives the first camera apparatus 14 to move relative to the base 12.

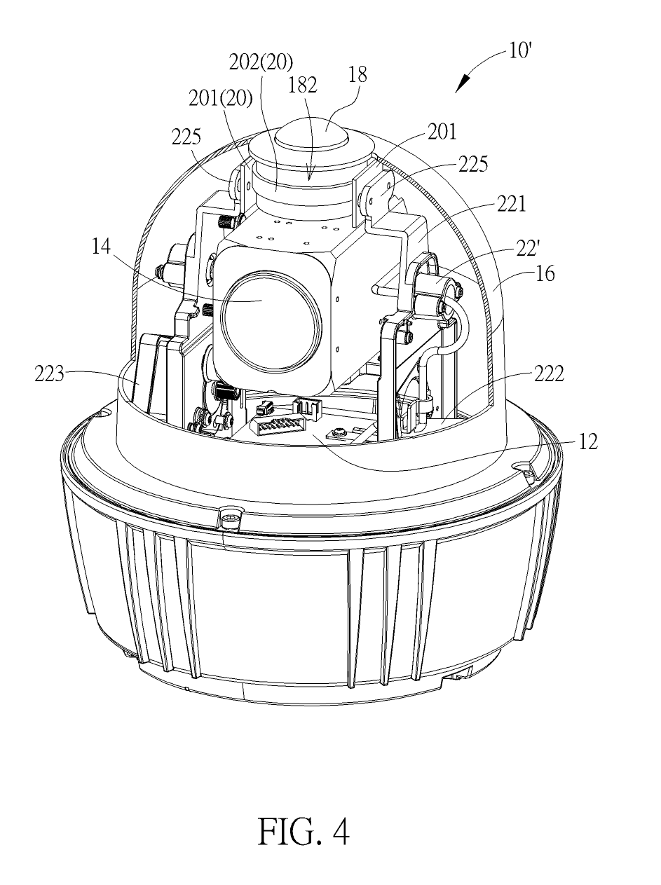

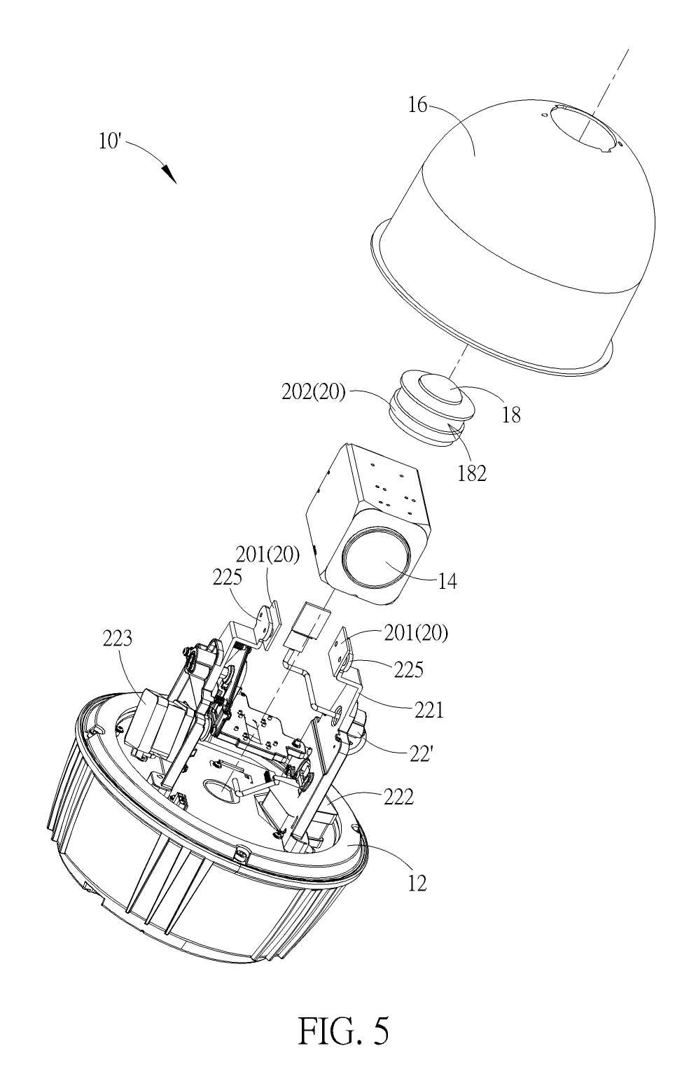

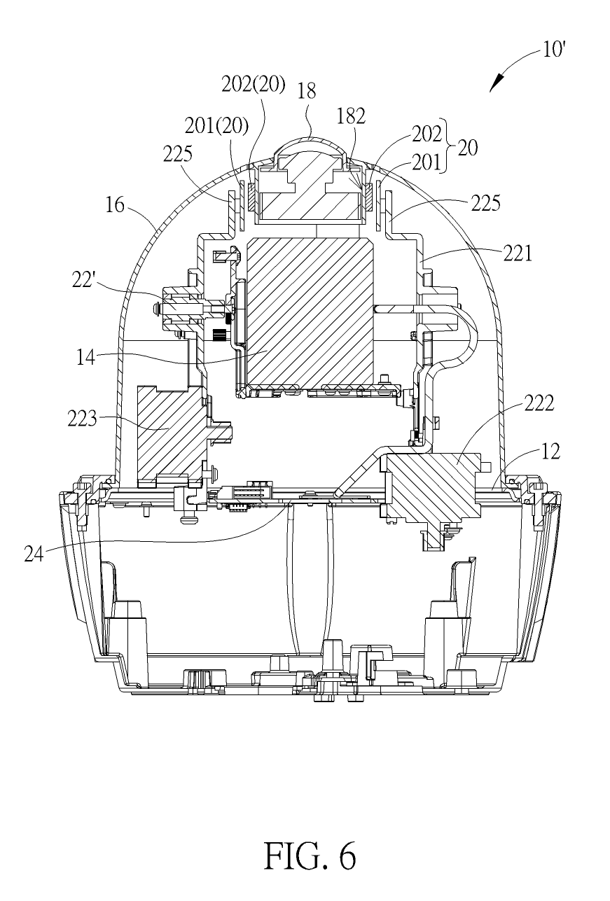

Please refer to FIG. 4 to FIG. 6. FIG. 4 is an assembly diagram of the camera system 10′ according to a second embodiment of the present invention. FIG. 5 is an exploded diagram of the camera system 10′ according to the second embodiment of the present invention. FIG. 6 is a sectional view of the camera system 10′ according to the second embodiment of the present invention. In the second embodiment, elements having the same numerals as ones of the first embodiment have the same structures and functions. Difference between the first embodiment and the second embodiment is the camera system 10′ includes the rotary mechanism 22′ having a surrounding portion 225 whereon the first terminal 201 is disposed. The surrounding portion 225 may stretch from the bracket 221. The surrounding portion 225 is adjacent to a lateral side 182 of the second camera apparatus 18, so the second terminal 202 is disposed on the foresaid lateral side 182 and can be continuously surrounded by the first terminal 201 while the rotary mechanism 22 drives the first camera apparatus 14 to move relative to the base 12.

A shape of the second camera apparatus 18 in the first embodiment can be cubic or cylindrical because the second terminal 202 is disposed on the bottom 181 and the first terminal 201 disposed on the bridging portion 224 is revolved on its own axis. By comparison, the shape of the second camera apparatus 18 in the second embodiment preferably should be the cylindrical structural design, the second terminal 202 has an arc according to the shape of the second camera apparatus 18, and the first terminal 201 has the same arc as ones of the second terminal 202 to keep the distance between the first terminal 201 and the second terminal 202 within the predetermined value while the first camera apparatus 14 is rotated relative to the base 12.

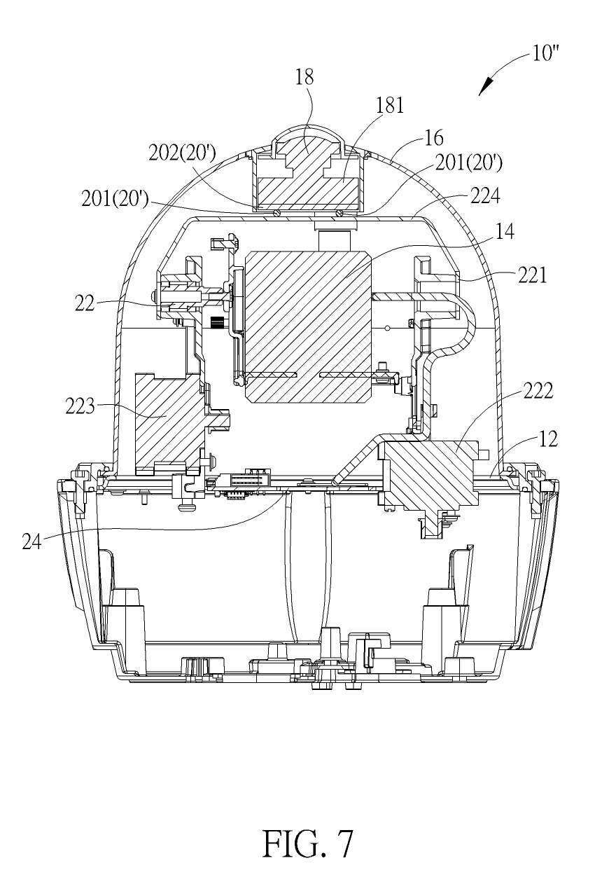

Please refer to FIG. 7. FIG. 7 is a diagram of the camera system 10″ according to a third embodiment of the present invention. In the third embodiment, elements having the same numerals as ones of the above-mentioned embodiments have the same structures and functions. Difference between the third embodiment and the above-mentioned embodiments is that the first terminal 201 and the second terminal 202 of the non-wired transmission module 20′ respectively can be a conductive roller and a conductive plate, and the conductive roller slides over the conductive plate in a substantial contacting manner for signal transmission. As shown in FIG. 7, the first terminal 201 and the second terminal 202 are not separated from each other while the first camera apparatus 14 is moved relative to the base 12, the first terminal 201 may be designed as the conductive roller, the electric brush, the elastic piece or any components with similar functions, and is utilized to continuously contact against the second terminal 202 no matter how the first camera apparatus 14 rotates relative to the base 12, so as to keep the transmission connection between the circuit board 24 and the second camera apparatus 18.

In the third embodiment, the first terminal 201 slidably contacts the second terminal 202 instead of a conventional wired cable transmission. The first terminal 201 moved relative to the second terminal 202 while the rotary mechanism 22 rotates the first camera apparatus 14 always touches the second terminal 202, an electrical connection between the first camera apparatus 14 and the second camera apparatus 18 is established via slidable contact of the first terminal 201 and the second terminal 202, and the said slidable contact provides preferred reliability and is not affected by over-rotation of the first camera apparatus 14. Application of the non-wired transmission module 20′ is not limited to foresaid assembly of the conductive roller and the conductive plate, which depends on design demand.

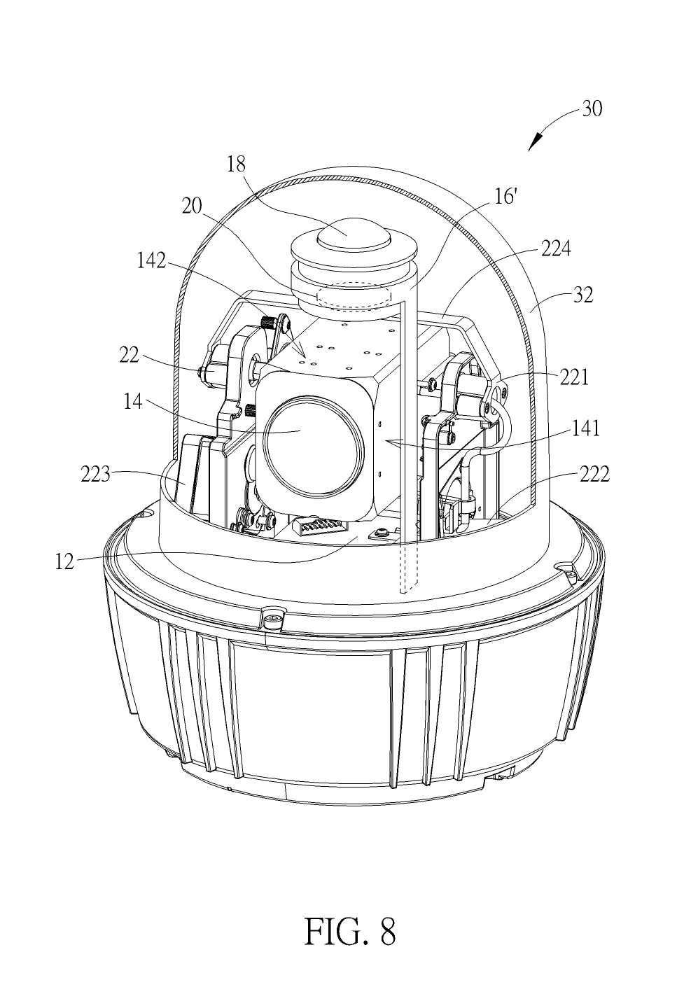

Please refer to FIG. 8. FIG. 8 is a diagram of the camera system 30 according to a fourth embodiment of the present invention. In the fourth embodiment, elements having the same numerals as ones of the above-mentioned embodiments have the same structures and functions. Difference between the fourth embodiment and the above-mentioned embodiments is the supporting component 16′ being a holder, and the camera system 30 further includes a cover 32 independent from the supporting component 16′. An end of the supporting component 16′ is disposed on the base 12 and adjacent by a surface 141 of the first camera apparatus 14. The other end (opposite to the foresaid end) of the supporting component 16′ whereon the second camera apparatus 18 is disposed is bent to be suspended upon another surface 142 of the first camera apparatus 14. The surface 141 and the surface 142 are connected but bent to each other.

The supporting component 16′ may be a kind of boom crutch. The supporting component 16′ stands on the base 12, a lever body of the supporting component 16′ is crooked to hang the second camera apparatus 18 upon the first camera apparatus 14, and the supporting component 16′ is separated from the first camera apparatus 14 by a distance, so that the first camera apparatus 14 does not hit the supporting component 16′ while being moved by the rotary mechanism 22. The cover 32 is assembled with the base 12 to shelter the first camera apparatus 14, the supporting component 16, the second camera apparatus 18, the wireless transmission module 20 and the rotary mechanism 22 from environmental pollution, such as dust and/or moisture. In the fourth embodiment, the second camera apparatus 18 is hidden inside and not connected with the cover 32, the user can individually replace the second camera apparatus 18 for increasing monitoring resolution or overcoming mechanical failure of the panoramic camera and still keep the current cover 32.

In the present invention, the wireless transmission module and the non-wired transmission module transmits a signal between the first camera apparatus and the second camera apparatus. The signal can be a power signal, image information, and/or a control command. The second camera apparatus receives the power signal for electric charge, which means the second camera apparatus may include a rechargeable battery unit adapted to receive and store the power signal. The second camera apparatus may have an individual control unit that drives an image capturing unit to acquire a panoramic image, or may receive the control command to accordingly execute an image capturing procedure. After that, the second camera apparatus transmits the image information, including the captured panoramic image, to the first camera apparatus or a processing unit of the camera system, and the panoramic image can be matched with an image captured by the first camera apparatus for providing the full view monitoring function.

Though the first terminal and the second terminal of the present invention are preferably connected with each other by the wireless transmission connection or the non-wired transmission, the camera still can utilize the physical cable to connect the second camera apparatus and the circuit board on the base. Two opposite ends of the physical cable can be respectively connected to the bottom of the second camera apparatus and a corresponding portion of the bracket of the rotary mechanism, to prevent the physical cable from damage by over-twisting while the rotary mechanism rotates the first camera apparatus relative to the base and the second camera apparatus. Moreover, a rotation axis of the first camera apparatus is substantially equal to a central axis of the second camera apparatus; while the first camera apparatus rotates relative to the second camera apparatus, an integral inertia moment of the camera system can be more stable due to centred disposition of the two camera apparatuses .

Comparing to the prior art, the camera system of the present invention combines the panoramic camera with the PTZ camera to provide the full view monitoring function. Overlap of the panoramic camera and the PTZ camera can increase stability of the integral inertia moment of the camera system. The wireless transmission connection is preferably applied to the camera system to overcome conventional constraint about cable length and cable quantity. The panoramic camera and/or the PTZ camera of the camera system can be modularized to be beneficial for product expansion and upgrading.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A camera system with a full view monitoring function, the camera system comprising:
a base whereon a circuit board is disposed;
a first camera apparatus movably disposed on the base and electrically connected with the circuit board;
a supporting component disposed on the base;
a second camera apparatus disposed on the supporting component to be located above the first camera apparatus; and
a wireless transmission module, comprising:
a first terminal electrically connected with the circuit board; and
a second terminal disposed on the second camera apparatus and adjacent by the first terminal, wireless transmission connection being established between the first terminal and the second terminal to electrically connect the second camera apparatus with the circuit board.

2. The camera system of claim 1, wherein the first terminal is spaced from the second terminal in a non-contacting manner, and a distance between the first terminal and the second terminal is constrained within a predetermined value while the first camera apparatus is moved relative to the base.

3. The camera system of claim 2, wherein a signal is transmitted between the first terminal and the second terminal by electromagnetic induction technique, magnetic resonance technique, laser induction technique, microwave transducing technique, voltage effect technique or electrical conduction technique.

4. The camera system of claim 1, wherein a rotation axis of the first camera apparatus is substantially equal to a central axis of the second camera apparatus.

5. The camera system of claim 1, wherein the supporting component is a protective mask assembled with the base, and the second camera apparatus is suspended from the protective mask.

6. The camera system of claim 5, wherein the second camera apparatus is disposed on the protective mask in an engaging manner, a locking manner, an adhesive manner or a thermal melting manner.

7. The camera system of claim 1, wherein the supporting component is a holder, an end of the holder is disposed on the base, and the other end of the holder whereon the second camera apparatus is disposed is bent to be suspended upon another surface connected to the foresaid surface of the first camera apparatus.

8. The camera system of claim 1, further comprising:
a rotary mechanism disposed on the base, the first camera apparatus being disposed on the rotary mechanism to move relative to the base.

9. The camera system of claim 8, wherein the rotary mechanism comprises a bridging portion adjacent to a bottom of the second camera apparatus, the first terminal is disposed on the bridging portion, and the second terminal is disposed on the bottom of the second camera apparatus.

10. The camera system of claim 8, wherein the rotary mechanism comprises a surrounding portion adjacent to a lateral side of the second camera apparatus, the first terminal is disposed on the surrounding portion, and the second terminal is disposed on the lateral side of the second camera apparatus.

11. The camera system of claim 8, wherein the first camera apparatus is panned and tilted by the rotary mechanism, and the second camera apparatus is a panoramic camera.

12. A camera system with a full view monitoring function, the camera system comprising:
a base whereon a circuit board is disposed;
a first camera apparatus movably disposed on the base and electrically connected with the circuit board;
a supporting component disposed on the base;
a second camera apparatus disposed on the supporting component to be located above the first camera apparatus; and
a non-wired transmission module, comprising:
a first terminal electrically connected with the circuit board; and
a second terminal disposed on the second camera apparatus and adapted to connect with the first terminal via removable contact, non-wired transmission connection being established between the first terminal and the second terminal to electrically connect the second camera apparatus with the circuit board.

13. The camera system of claim 12, wherein the first terminal slidably contacts against the second terminal, the first terminal is not separated from the second terminal while the first camera apparatus is moved relative to the base.

14. The camera system of claim 13, wherein the first terminal and the second terminal respectively are a conductive roller and a conductive plate, and the conductive roller slides over the conductive plate for signal transmission.

15. The camera system of claim 12, wherein the supporting component is a protective mask assembled with the base, and the second camera apparatus is suspended from the protective mask.

16. The camera system of claim 15, wherein the second camera apparatus is disposed on the protective mask in an engaging manner, a locking manner, an adhesive manner or a thermal melting manner.

17. The camera system of claim 12, wherein the supporting component is a holder, an end of the holder is disposed on the base, and the other end of the holder whereon the second camera apparatus is disposed is bent to be suspended upon another surface connected to the foresaid surface of the first camera apparatus.

18. The camera system of claim 12, further comprising:
a rotary mechanism disposed on the base, the first camera apparatus being disposed on the rotary mechanism to move relative to the base.

19. The camera system of claim 18, wherein the rotary mechanism comprises a bridging portion adjacent to a bottom of the second camera apparatus, the first terminal is disposed on the bridging portion, and the second terminal is disposed on the bottom of the second camera apparatus.

20. The camera system of claim 18, wherein the rotary mechanism comprises a surrounding portion adjacent to a lateral side of the second camera apparatus, the first terminal is disposed on the surrounding portion, and the second terminal is disposed on the lateral side of the second camera apparatus.
